(19) United States
(12) Patent Application Publication
(10) Pub. No.: US 2023/0324578 A1
(43) Pub. Date: Oct. 12, 2023

(54) Apparatus for Detecting Metal Objects in and on Articles Moving Relative to the Apparatus

(71) Applicant: Cassel Messtechnik GmbH, Dransfeld (DE)

(72) Inventor: Matthias Schulz, Bovenden (DE)

(21) Appl. No.: 18/210,128

(22) Filed: Jun. 15, 2023

Related U.S. Application Data
(63) Continuation of application No. PCT/EP2021/085682, filed on Dec. 14, 2021.

(30) Foreign Application Priority Data
Dec. 16, 2020 (EP) 20 214 737.7

(51) Int. Cl. G01V 3/10

(52) U.S. Cl. CPC G01V 3/10

(57) ABSTRACT

An apparatus servs for detecting metal objects in and on articles moving relative to the apparatus. The apparatus comprises a transmitter device including a transmitter coil and configured for generating a magnetic alternating field at multiple operating frequencies using the transmitter coil, a receiver device including at least one receiver coil and configured for detecting the magnetic alternating field influenced by the moving articles and for outputting a receiver signal as a function of the detected magnetic alternating field, a filter device configured for filtering multiple partial signals out of the receiver signal, each of the partial signals being associated with one of the operating frequencies, and an analysis device configured for analyzing the partial signals. The filter device is configured for band-elimination filtering each of the partial signals which is associated with one of the operating frequencies with regard to all others of the operating frequencies.

### CROSS REFERENCE TO RELATED APPLICATIONS

This application is a continuation of International Application PCT/EP2021/085682 with an international filing date of Dec. 14, 2021 and claiming priority to European Patent Application No. EP 20 214 737.7 entitled “Vorrichtung zur Detektion von metallischen Objekten in and an sich gegenüber der Vorrichtung bewegenden Gegenständen”, filed on Dec. 16, 2020.

### FIELD OF THE INVENTION

The present invention generally relates to an apparatus for detecting metal objects in and on articles moving relative to the apparatus. More particularly the present invention relates to a such an apparatus for detecting metal objects in and on articles moving relative to the apparatus which has a transmitter device for generating a magnetic alternating field at multiple operating frequencies, a receiver device for detecting the magnetic alternating field influenced by the moving articles and for outputting a receiver signal as a function of the detected magnetic alternating field, a filter device configured for filtering multiple partial signals out of the receiver signal, each of the partial signals being associated with one of the operating frequencies, and an analysis device configured for analyzing the partial signals.

### BACKGROUND OF THE INVENTION

The non-invasive examination of articles with regard to whether they include metal objects is applied on various technical fields. One field is the inspection of products in, for example, the food and other consumer goods industries for metal contamination. Another field is the protection of processing machines against metal objects which could damage the processing machines. Even another field is the inspection of persons for weapons carried, i.e. the articles to be inspected may also be people. Here, it is essential to determine whether the respective article, which may, for example, itself be electrically conductive due to its water or salt content, includes a metal object which differentiates it from an orderly or harmless article.

A metal detection system comprising a transmitter coil and two receiver coils which are symmetrically arranged with respect to the transmitter coil and connected in series in quadrupole configuration is known from European patent EP 2 625 551 B1 and U.S. Pat. No. 8,587,301 belonging to the same patent family. The transmitter coil is connected to a transmitter unit which outputs transmitter signals of selectable operating frequencies. The receiver coils connected in series are connected to an analysis device via a filter device. Without a metal object in the metal detection system, the voltages induced in the two receiver coils balance. If a metal object is passed through the coils, receiver signals occur which are dependent on the properties of the metal object. The analysis device analyses the receiver signals with respect to phase and amplitude. At first, at different operating frequencies of the transmitter unit, phases and amplitudes of the associated receiver signal are determined for the respective product with a metal contamination of different particle sizes. Multiple operating frequencies are determined therefrom, at which the differences of the receiver signals as compared to the non-contaminated product are particularly high. These determined operating frequencies are then simultaneously applied by the transmitter unit in the operation of the metal detection systems. The receiver signals are filtered in the filter device correspondingly, and then analyzed in the analysis device separately from one another.

A metal detection apparatus comprising a transmitter device including a transmitter coil and a receiver device including two receiver coils connected in series in quadrupole configuration, wherein the transmitter coil is part of a parallel oscillator circuit of the transmitter device, is known from European patent application publication EP 2 562 565 A1 and U.S. Pat. No. 8,841,903 belonging to the same patent family. The resonance frequency of the oscillator circuit of the transmitter device is an operating frequency of the transmitter coil. The operating frequency is switchable in that a capacitance in the parallel oscillator circuit may be switched between predetermined values. Thus, this known metal detection apparatus may be operated at the operating frequency most suitable in the individual case or with different operating frequencies one after the other.

A metal detection apparatus in which a transmitter coil is part of a resonant oscillator circuit of a transmitter device and in which two receiver coils which are connected in series in quadrupole configuration are part of a resonant oscillator circuit of a receiver device are known from German patent application publication DE 10 2012 013 554 A1. A device for balancing the transmitter coil and the receiver coils comprises a capacitor decade for freely selected adjustment of resonance frequencies of both oscillator circuits. The oscillator circuits may be parallel oscillator circuits or series oscillator circuits. The respective resonance frequency of the oscillator circuit of the transmitter device is the operating frequency of the transmitter coil, and the resonance frequency of the oscillator circuit of the receiver device is tuned to this operating frequency. In this way, the responsiveness of the metal detection apparatus is increased.

A metal detection apparatus comprising the features of the preamble of independent claim 1 is known from European patent EP 1 760 494 B1 and U.S. Pat. No. 7,663,361 belonging to the same patent family. The transmitter coil of the transmitter device is part of a multi-resonant oscillator circuit which has a resonance frequency at each of the multiple operating frequencies of the metal detection apparatus.

An identification system for detecting objects consisting of a transmitter coil unit which is excited by a generator at a variable frequency, and a detector block to be attached to an object to be identified and having one or more resonant circuits which are each tuned to another frequency, is known from German patent application publication DE 30 23 446 A1. The transmitter coil unit consists of two equal transmitter coils connected in counter-phase which are arranged such that the resultant of the magnetic field in a measurement coil arranged between them is zero in the absence of a resonant circuit in an operating area and different to zero in its presence. The excited resonant circuit disturbs the magnetic field of the transmitter coils and induces a voltage in the measurement coil. In that, in an effective range, a resonant circuit in the detector block that is tuned to a certain frequency is excited for oscillations by means of the signal transmitted at the respective frequency, it may be exactly determined which detector block causes the disturbance of the magnetic field by means of which resonant circuit. In that, in the detector block, different resonant circuits tuned to different frequencies are arranged, a high number of detector blocks may be differentiated. Depending on the number of the objects to be identified, more or less frequencies and more or less tuned circuits may be used.

A metal detection system comprising the features of the preamble of independent claim 1 is known from US patent application publication US 2012/0 086 455 A1. The filter device comprises a band pass filter.

A metal detection system comprising the features of the preamble of independent claim 1, in which the analysis device demodulates each of the partial signals at one of the operating frequencies with respect to contained phase information is known from US patent application publication US 2015/0 276 964 A1.

There still is a need of an apparatus which detects metal objects of different size at any position in or on articles moved relative to the apparatus at a high sensitivity, even if the articles are electrically conductive themselves or generally hamper the detection of metal objects by electric or dielectric properties.

### SUMMARY OF THE INVENTION

The present invention relates to an apparatus for detecting metal objects in and on articles moving relative to the apparatus. The apparatus comprises a transmitter device including a transmitter coil and configured for generating a magnetic alternating field at multiple operating frequencies using the transmitter coil, a receiver device including at least one receiver coil and configured for detecting the magnetic alternating field influenced by the moving articles and for outputting a receiver signal as a function of the detected magnetic alternating field, a filter device configured for filtering multiple partial signals out of the receiver signal, each of the partial signals being associated with one of the operating frequencies, and an analysis device configured for analyzing the partial signals. The filter device is configured for band-elimination filtering each of the partial signals which is associated with one of the operating frequencies with regard to all others of the operating frequencies.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a schematic view of an embodiment of the apparatus for detecting metal objects in and on articles moving relative to the apparatus.

FIG. 2 shows a first embodiment of an oscillator circuit of a transmitter device of the apparatus according to FIG. 1.

FIG. 3 shows a first embodiment of an oscillator circuit of a receiver device of the apparatus according to FIG. 1.

FIG. 4 shows a second embodiment of the oscillator circuit of the transmitter device of the apparatus according to FIG. 1.

FIG. 5 shows a second embodiment of the oscillator circuit of the receiver device of the apparatus according to FIG. 1 with switchable capacitances corresponding to the embodiment of the oscillator circuit according to FIG. 4.

FIG. 6 shows a variant of the embodiment of the oscillator circuit of the receiver device according to FIG. 5 with an additional switchable inductance.

FIG. 7 shows a further embodiment of the oscillator circuit of the receiver device of the apparatus according to FIG. 1 with switchable capacitances, which is based on the embodiment of the oscillator circuit of the receiver device according to FIG. 3.

FIG. 8 shows a variant of the embodiment of the oscillator circuit of the receiver device according to FIG. 7 having an additional switchable inductance.

FIG. 9 is a schematic diagram of a first embodiment of a filter device of the apparatus according to FIG. 1.

FIG. 10 is a schematic diagram of a second embodiment of the filter device of the apparatus according to FIG. 1.

FIG. 11 illustrates the formation of a band elimination filter of the filter device according to FIGS. 9 and 10 of a group of three individual notch filters.

FIG. 12 shows a resulting transmission spectrum of the group of notch filters according to FIG. 11.

FIG. 13 illustrates an embodiment of an analysis device of the apparatus according to FIG. 1; and

FIG. 14 is a schematic view of a further embodiment of the apparatus for detecting metal objects in and on articles moving relative to the apparatus with additional balancer devices.

### DETAILED DESCRIPTION

In an apparatus according to the present disclosure for detecting metal objects in or on articles moving relative to the apparatus, a transmitter device generates an alternating magnetic field that has multiple operating frequencies using a transmitter coil. A receiver device of the apparatus detects the alternating field influenced by the moving articles using at least one receiver coil and outputs a receiver signal as a function of the detected electric alternating field. A filter device of the apparatus filters partial signals out of the receiver signal, which are each associated with one of the operating frequencies. An analysis device of the apparatus analyses the partial signals. The filter device of the apparatus according to the present disclosure band-elimination filters each of the partial signals which is associated with one of the operating frequencies with respect to all others of the operating frequencies. Band elimination filtering of the other operating frequencies which strongly suppresses the receiver signal at these other operating frequencies comprises a low increase of the frequency dependent phase response and, thus, a lower sensitivity with respect to smaller frequency shifts and temperature drifts than narrow-band band pass filtering at the associated operating frequency of the partial signal to be passed through. Particularly, there is no strong frequency dependency of the influence on the phase of the partial signal at the respective operating frequency. This is important, because a certain shift of the operating frequency with respect to the filter frequencies, for example due thermal influences, may practically not be avoided in operation of industrial apparatus for detecting metal objects. In contrast to narrow-band band pass filtering with a deep blocking range, the strongest influence on the phase of the receiver signal in band elimination filtering according to the present disclosure occurs at the respective other operating frequencies far away in the frequency space from the operating frequency associated with the respective partial signal of interest. This applies without limitation to a large dynamic range of the partial signal achieved by the filtering, and means a high over modulation robustness, i.e. a sufficient headroom to a signal clipping threshold, of the subsequent signal processing of the respective partial signal of interest at the associated operating frequency.

In order to implement the band elimination filtering in the filter device of the apparatus according to the present disclosure, the filter device may have a group of at least two notch filters for each of the partial signals and each of the others of the operating frequencies. The group of notch filters may comprise a first notch filter having a first central filter frequency which may be tuned to the respective one of the others of the operating frequencies. Further, the group of notch filters may have at least one of a second and a third notch filter having a second central frequency and a third central filter frequency, which may each by 1% to 10% be lower or higher than the first central filter frequency. Thus, the group of notch filters, as a whole, has a transmission spectrum with a deeper and broader blocking range than a single notch filter.

The filter device of the apparatus according to the present disclosure may further have a band pass filter or a low pass filter or a high pass filter for each of the partial signals, wherein each edge of the respective filter keeps a distance of at least 10% of the operating frequency to the operating frequency with which the respective partial signal is associated. Even if the filter device, after all, has a band pass filter for the respective operating frequency, this band pass filter is very broad with a large distance of its edges to the operating frequency and, thus, with a low influence on the partial signal at the operating frequency. The distance of each edge of the respective filter to the respective operating frequency may be 20% or even 30% of the operating frequency.

In order to achieve a high sensitivity of the apparatus according to the present disclosure in that as much information about any metal objects in the moved articles is obtained as possible, the transmitter coil may be part of a multi-resonant oscillator circuit of the transmitter device, which has one resonance frequency at each of the multiple operating frequencies. Alternatively or additionally, the at least one receiver coil is part of a multi-resonant oscillator circuit of the receiver device, which has a resonance frequency at each of the multiple operating frequencies. Further, both the transmitter device and the receiver device may have such a multi-resonant oscillator circuit, wherein the resonance frequencies of the two oscillator circuits are tuned to each other.

Then, the filter device of the apparatus according to the present disclosure may band elimination filter each of the partial signals which is associated with one of the operating frequencies also with respect to all other resonance frequencies of the multi-resonant oscillator circuit of the receiver device.

Due to the multi-resonant oscillator circuits, the apparatus according to the present disclosure has a high responsiveness and, thus, overall a very high sensitivity to metal objects. In the transmitter device, the excitation signals for the individual operating frequencies are added up to a sum signal. The addition may take place electronically or in a signal transformer at an input of the multi-resonant oscillator circuit of the transmitter device. It is sufficient to add up the excitations at the individual operating frequencies. At the receiver side, the receiver signal coming from the receiver device is filtered in the filter device in such a way that the partial signals which are each associated with one of the operating frequencies are separated from one another and are as far as possible not varied in doing do. In using the apparatus according to the present disclosure with multi-resonant oscillator circuits, the partial signals result in a comparatively high signal to noise ratio and may, thus, be relatively easily filtered by the filter device and easily analyzed by the analysis device. Thus, even smaller metal objects in and on the articles examined with the apparatus according to the present disclosure are detectable, even if the articles themselves have at least one of pronounced electric and pronounced dielectric properties and therefore themselves strongly influence the alternating magnetic field generated using the transmitter coil, i.e. themselves result in a high receiver signal whose relative changes due to the additional presence of a metal object to be detected remain small. Due to the multiple operating frequencies of the transmitter device used simultaneously, these changes due to the metal object to be detected are simultaneously determined at these multiple operating frequencies and, thus, at a high probability, also at an operating frequency at which they are well observable and, thus, allow for a reliable detection of the metal object. Further, the simultaneous changes of the receiver signal by the metal object to be detected at the different operating frequencies may be interrelated so that there is broader data base for the secure detection of the metal object.

Each multi-resonant oscillator circuit of the apparatus according to the present disclosure typically comprises interconnected partial oscillator circuits, and these interconnected partial oscillator circuits may each include a series oscillator circuit and a parallel oscillator circuit. It is generally known that an oscillator circuit which consists of a series oscillator circuit and of an interconnected parallel oscillator circuit has multiple, i.e. exactly three, resonances. Two of the three resonances are parallel resonances having a local maximum of the impedance. The parallel resonances result from the coupled cooperation of the inductances and capacitances of both interconnected partial oscillator circuits and may, in the proximity of their respective resonance frequency, be used for the signals at the operating frequencies of the apparatus according to the present disclosure. The third resonance is a series resonance at which the impedance for an excitation signal for exciting the oscillator circuit of the transmitter device or the receiver signal for being coupled out of the oscillator circuit of the receiver device has a local minimum, and its resonance frequency is between the two resonance frequencies of the parallel resonances. The resonance frequency of the third resonance is only determined by the series resonance of the series oscillator circuit not influenced by the parallel oscillator circuit. In order to realize three or more useable resonance frequencies, more than one series oscillator circuit and one parallel oscillator circuit are to be interconnected in the respective multi-resonant oscillator circuit. Each additional operating frequency increases, besides the complexity of the multi-resonant circuit, the effort needed to filter the partial signals which are each associated with one of the operating frequencies out of the receiver signal, and to electronically process them in the filter device. Thus, in practice, it may be suitable to limit the number of resonance frequencies used as operating frequencies to two or three.

In the apparatus according to the present disclosure, the transmitter device may be switchable between a plurality of predetermined sets of operating frequencies to optimally adapt the operating frequencies to the articles to be examined, i.e. to their electric and dielectric properties, and also to particularly relevant metal objects. Then, each multi-resonant oscillator circuit of the apparatus is switchable to tune its resonance frequencies to the respective set of operating frequencies. In practice, this may be realized in that the capacitances of all partial oscillator circuits which are interconnected in the respective multi-resonant oscillator circuit are switchable between adapted predetermined values. Generally, it is sufficient to only switch-over one capacitance in one of the partial oscillator circuits of the respective oscillator circuit in order to switch to another set of operating frequencies. However, with a coordinated switching-over, like for example a quadruplication of all capacitances, the value of all resonance frequencies of the respective oscillator circuit may be altered by a same factor, in the given example to a half, so that their frequency ratio remains the same. Further, it is possible to vary the distance of the resonance frequencies of each multi-resonant oscillator circuit of the device purposefully in that an inductance in one of the partial oscillator circuits of the respective oscillator circuit is switched-over. Suitably, this is the inductance of a coil or a coil arrangement which is not the transmitter coil or the at least one receiver coil or a receiver coil arrangement at the same time.

In the apparatus according to the present disclosure, it may be advantageous that each multi-resonant oscillator circuit, at each of the multiple operating frequencies, i.e. at its corresponding resonance frequency, has a quality factor of at least 10, in order achieve the desired sensitivity. The smaller the respective operating frequency the more laborious it is to achieve a high quality factor. Thus, the quality factor which is achieved at the lowest of the multiple operating frequencies may be at least 15, and the quality factor which is achieved at the highest of the multiple operating frequencies may be at least 30. A very high quality factor of the respective multi-resonant oscillator frequency is not desired in the apparatus according to the present disclosure. This particularly applies to quality factor of 100 or more, because, with increasing quality factor, the influence of the phase of the partial signals at the respective operating frequency due to temperature-dependent resonance properties of the oscillator circuit may, to an increasing extent, affect the quality of the signal processing.

The analysis device of the apparatus according to the present disclosure may, in a generally known way, be configured for demodulating each of the partial signals with respect to contained phase information using a reference signal of the operating frequency associated with the respective partial signal.

Further, the receiver device, also in a generally known way, may have two equal receiver coils which may have the same geometry as the transmitter coil, which are symmetrically arranged in planes parallel to the transmitter coil, and which are connected in series in the receiver device, particularly in quadrupole configuration in the oscillator circuit of the receiver device. Thus, a receiver signal only arises in the receiver device if the symmetry of this arrangement is disturbed by an article which has a different influence on the alternating magnetic field emanating from the transmitter coil on the one side than on the other side of the transmitter coil. Such a disturbance of the symmetry is caused by each article moving relative to the apparatus, particularly through its coils. The course of the disturbance depends on the respective article and its electric and dielectric properties. An additional disturbance results from a metal object in or on the respective article. The course of this additional disturbance depends on the size, shape and the material of the metal object, and on its position in or on the respective article. Thus, the course of the disturbance depending on the movement of the article relative to the apparatus and the receiver signal resulting therefrom in the receiver device allows for drawing conclusions on whether the respective article includes a metal object. Further, conclusions on at least one of the position, the material and the size of the metal object in the respective article may be possible.

Even if, in principle, equal receiver coils are symmetrically arranged in planes parallel to the transmitter coil and connected in series in quadrupole configuration in the receiver device, a receiver signal different from zero may occur, even prior to the influence of articles moved relative to the apparatus according to the present disclosure on the alternating magnetic field generated by the transmitter coil. Thus, it is generally known to provide a balancer device which is configured for balancing the receiver signal at the respective operating frequencies of the apparatus towards zero, if the alternating magnetic fields is not yet influenced by the moving articles. In the apparatus according to the present disclosure, this balancing is to be carried out simultaneously for all of the multiple operating frequencies. For this purpose, the apparatus according to the present disclosure may comprise an own, i.e. separate, balancer device for each of the operating frequencies with low crosstalk to the partial signals at the respective other operating frequency.

In practice, one of the balancer devices, particularly the balancer device for the highest of the operating frequencies, may comprise at least one capacitor or one ohmic resistor, which is connected in parallel to one of the two receiver coils in order to balance the properties of the two receiver coils at this operating frequency directly in the oscillator circuit of the receiver device. For balancing the receiver device at the operating frequency towards zero, at least one of the capacitor and the ohmic resistor may be adjustable in steps. However, the balancer device may also be equipped with fixed components, because the relevant properties of both receiver coils and thus their differences remain constant, as a rule.

The separate balancer device for each further operating frequency may have a transformer, a part of the exciting signal that is primarily used for exciting the transmitter device at the respective operating frequency being present at a primary winding of this transformer. The secondary winding of this transformer comprises two winding halves and a center point between the two winding halves. The center point of the secondary winding is connected to a reference ground of a signal output of the receiver device for the receiver signal. At least one capacitor or ohmic resistor is connected between one of the winding halves of the secondary winding and the signal output of the receiver device. Thus, at the respective operating frequency, a balancing signal which is adjustable with respect to its phase and amplitude by dimensioning or, if possible, adjusting the ohmic resistors and capacitors connected in parallel is added to the signal output of the receiver device via the transformer. Thus, the receiver signal may also be balanced towards zero at the respective further operating frequency. Because the relevant properties of the two receiver coils and thus also their differences, as already mentioned, remain constant, as a rule, each separate balancer device for each further operating frequency may also be equipped with fixed components.

Additionally, the partial signals output by the filter device of the apparatus according to the present disclosure, which are each associated with one of the operating frequencies, may be added to signals, which are derived from the respective part of the excitation signal for the transmitter device in such a controlled way that the partial signals are zero in the temporal average. This adjustment may compensate for aging and temperature drifts, but it is varied so slowly that it does not significantly attenuate the changes of the partial signals due to the articles moved relative to the apparatus.

By means of all these measures, the filter device and the analysis device of the apparatus according to the present disclosure may be more closely adapted to the information containing parts of the receiver signal.

The analysis device of the apparatus according to the present disclosure may be configured to interrelate the information obtained at the multiple operating frequencies in order to detect the metal objects in or on the particles moving relative to the apparatus. For example, a course of a ratio or a difference of the partial signals or of phase information obtained therefrom may be evaluated. The courses of these values may more strongly depend on certain properties of the metal objects than the individually observed partial signals or information directly derived therefrom.

In practice, the information obtained at the multiple operating frequencies may be interrelated depending on the associated points in time at which the receiver signal on which they are based has been registered. Alternatively, the information obtained at the multiple operating frequencies may be interrelated depending on the associated positions of the respective articles relative to the apparatus. Often, these temporal and spatial observations are of equal value, because the articles which are examined with the apparatus according to the present disclosure, for example on a conveyor belt, move at a constant velocity relative to the apparatus. The fact that the articles move relative to the apparatus according to the present disclosure, may, in practice, mean that the articles are conveyed through the transmitter coil and all receiver coils of the apparatus, and particularly in a conveying direction orthogonal to the coil planes. However, it is, for example, also possible to convey the articles in a conveying direction parallel or only along the coil planes past the transmitter coil and all receiver coils of the apparatus.

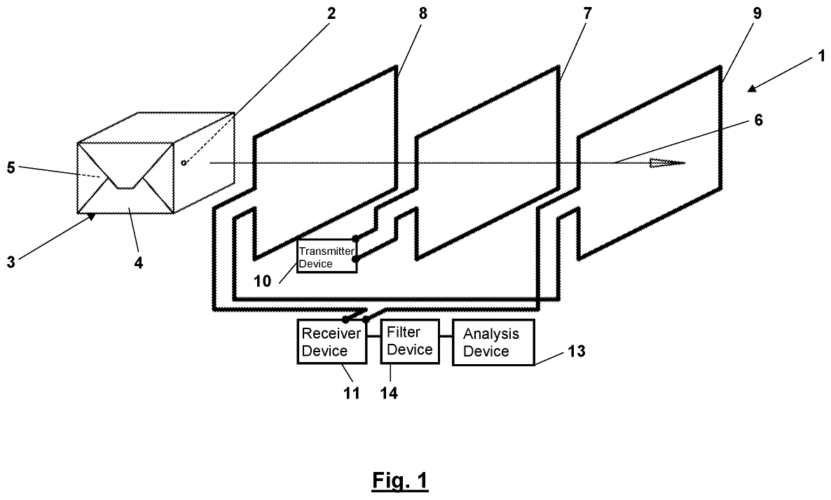

Referring now in greater detail to the drawings, the apparatus 1 which is depicted in an embodiment in FIG. 1 serves for detecting metal objects 2 in or on articles 3 which are moved relative to the apparatus. In FIG. 1, a product 5 packed in box 4 is depicted as the article 3 in which a metal object 2 may be present. The article 3 is moved in a conveying direction 6, like, for example, on a conveyor belt not depicted here, through coils 7 to 9 of the apparatus 1. The coils 7 to 9 which are only depicted with a single winding here may have multiple windings. The center coil is a transmitter coil 7 which is a part of a transmitter device 10. The outer coils are two receiver coils 8 and 9. The receiver coils 8 and 9 are symmetrically arranged with respect to the transmitter coil 7 in planes parallel to the transmitter coil 7, and typically closer to the transmitter coil 7 than suggested by FIG. 1. The receiver coils 8 and 9 may have the same geometry, i.e. geometric shape and size as the transmitter coil 7. The receiver coils 8 and 9 are part of a receiver device 11 and are connected in series in quadrupole configuration. The transmitter device 10 is configured for generating an alternating magnetic field using the transmitter coil 7. The receiver device 11 detects the alternating magnetic field with the receiver coils 8 and 9. Due to the symmetric arrangement and the interconnection of the receiver coils 8 and 9 in quadrupole configuration, no receiver signal occurs as long as the magnetic configuration in the apparatus 1 is symmetric with respect to the transmitter coil 7. When the article 3 moves through the coils 7 to 9, the symmetry of the magnetic configuration is disturbed, and there is a course of the receiver signal characteristic of the article 3 over its path through the apparatus 1. If the metal object 2 is present in or on the article 3, a significantly different characteristic course of the receiver signal results than without the metal object 2. The respective course of the receiver signal is also dependent on the operating frequency at which the alternating magnetic field is generated using the transmitter coil 7. The apparatus 1 is configured for that the transmitter device 10 generates the alternating magnetic field simultaneously at multiple operating frequencies using the transmitter coil 7, and in that the receiver signal from the receiver coils 8 and 9 is at first separately analyzed at each of these operating frequencies. For this purpose, a filter device 14 is connected between the receiver device 11 and an analysis device 13, which filters partial signals out of the receiver signal that each correspond to one of the operating frequencies. These partial signals are analyzed by the analysis device 13.

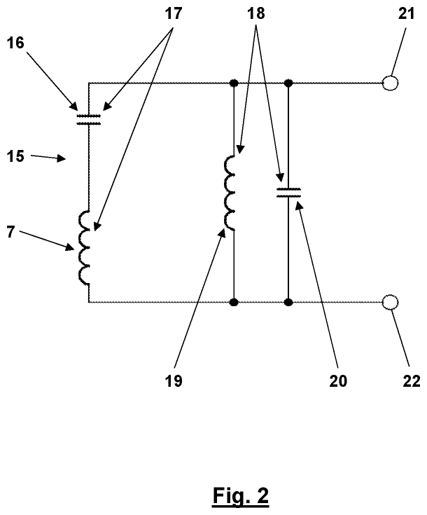

FIG. 2 shows a multi-resonant oscillator circuit 15 which is part of an embodiment of the transmitter device 10 according to FIG. 1 and includes the transmitter coil 7. The transmitter coil 7, together with a first capacitor 16, is part of a series oscillator circuit 17 which is interconnected with a parallel oscillator circuit 18 made of a second coil 19 and a second capacitor 20. The oscillator circuit 15 comprises multiple resonance frequencies which are usable as operating frequencies. Via connectors 21 and 22, the oscillator circuit 15 is excitable for oscillations and, thus, for generating alternating magnetic fields via the transmitter coil 7. Instead of using the coil of the series oscillator circuit 17 as the transmitter coil 7, the coil 19 of the parallel oscillator circuit 18 could be used as the transmitter coil.

A multi-resonant oscillator circuit of the receiver device 11 may, in principle, be identically designed as the oscillator circuit 15 according to FIG. 2, wherein, at the place of the transmitter coil 7, the two receiver coils 8 and 9 are connected in series in quadrupole configuration.

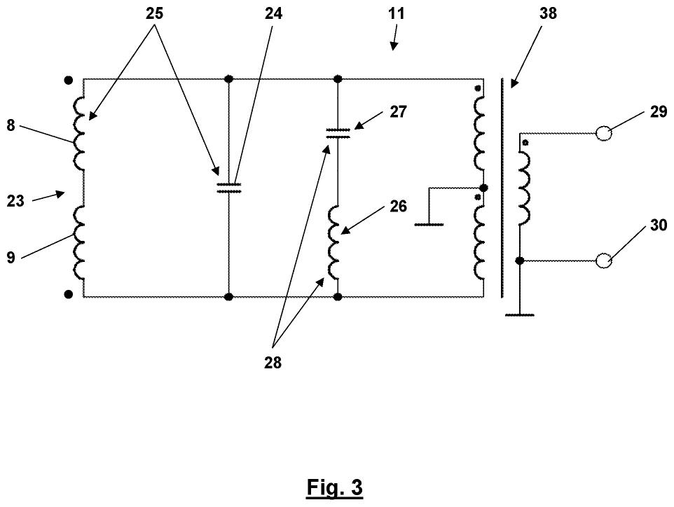

FIG. 3 shows a multi-resonant oscillator circuit 23 of the receiver device 11 in which the receiver coils 8 and 9 together with a capacitor 24 form a partial oscillator circuit made as a parallel oscillator circuit. A further coil 26 and a further capacitor 27 form a series oscillator circuit 28 interconnected therewith. Further, FIG. 3 shows how the, at first, symmetric receiver signal of the receiver device 11 may be provided with a suitably chosen impedance via a transformer 38 and unbalanced, i.e. as an unbalanced signal, at connectors 29 and 30 to the filter device 14 according to FIG. 1. Here, the primary side and the secondary side of the transformer 38 have a fixed relation to ground. The transformer 38 is designed such that its influence on the multi-resonant oscillator circuit 23 remains small. The transformer 38 may be provided for increasing the voltage of the receiver signal at the connectors 29 and 30. A transformer corresponding to the transformer 38 may also be provided in the transmitter device 10 in order to connect a signal generator with adapted impedance and symmetry of an excitation signal provided by it to the oscillator circuit 15. Thus, the transformer 38 is an option with all oscillator circuits depicted in FIGS. 2 to 8.

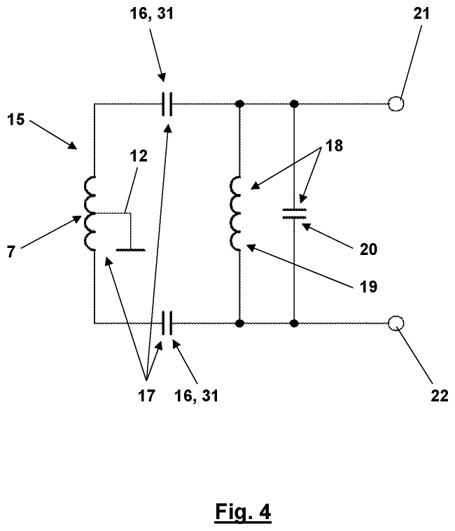

According to FIG. 4, which once again shows the oscillator circuit 15 of the transmitter device 10, the capacitor 16 of the series oscillator circuit 17 is divided up into two equal partial capacitors 31. Thus, the series oscillator circuit 17 and also the entire oscillator circuit 15 is symmetric with regard to a center point of the transmitter coil 7. Further, a galvanic de-coupling is achieved which makes it easier to provide the transmitter coil 7 with a fixed potential reference. According to FIG. 4, the center point of the transmitter coil 7 is connected to ground via a center point tap 12. Thus, a symmetric operation of the transmitter coil 7 results. Instead of the depicted direct connection of the center point of the transmitter coil 7 to ground, there may be a connection via a resistor which is high-ohmic as compared to the impedance of the transmitter coil 7 at the operating frequencies. Further, the ends of the transmitter coil 7 may be connected to ground via equal high-ohmic resistors to provide the potential reference.

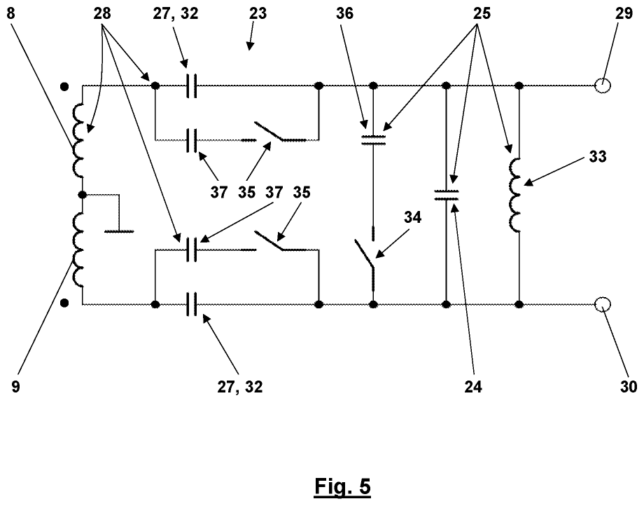

FIG. 5 shows an embodiment of the oscillator circuit 23 of the receiver device 11 corresponding to the oscillator circuit 15 of the transmitter device 10 according to FIG. 4. Here, the receiver coils 8 and 9 are part of the series oscillator circuit 28 in which the capacitor 27 of FIG. 3 is split up into partial capacitors 32, and a further coil 33, together with the capacitor 24, forms the parallel oscillator circuit 25. The center point between the receiver coils 8 and 9 is connected to ground to provide for a reference potential. Here, instead of the depicted direct connection of the center point to ground, a connection via a resistor may be given which is high-ohmic as compared to the impedance of the receiver coils 8 and 9 at the operating frequencies. Further the opposing outer ends of the two receiver coils 8 and 9 may be connected to ground via equal high-ohmic resistors to provide for a potential reference.

Further circuit variants are possible in order to form multi-resonant oscillator circuits 15 and 23 of the transmitter device 10 and the receiver device 11. It is decisive that multiple resonance frequencies are available as operating frequencies for the transmitter device 10 or in the receiver device 11 for adaptation to the operating frequencies of the transmitter device. The exact position of the resonance frequencies is determined by the capacitances of the capacitors 16, 20, 24, 27 and the inductances of the coils 7 to 9, 19, 26, 33 of the partial oscillator circuits of the oscillator circuits 15 and 23. By a suitable selection of these capacitances and inductances, the resonance frequencies of the oscillator circuits 15, 23, may be tuned to desired values.

FIG. 5 also shows how, with the help of switches 34 and 35, by means of simultaneously switching-on further parallel capacitors 36 and 37, the capacitances in the parallel oscillator circuit 25 and the series oscillator circuit 28 can be increased. In this way, the resonance frequencies of the oscillator circuit 23 are shifted towards smaller frequencies, wherein a given frequency ratio of the resonance frequencies may be maintained.

In a particular embodiment of the oscillator circuit 23 of the receiver device 11 according to FIG. 5 for an apparatus 1 for detecting metal objects 2 with higher operating frequencies, if only the capacitances of the partial capacitors 32 and the capacitor 24 are active, the lower one of the two operating frequencies is 150 kHz and the higher one of the two operating frequencies is 600 kHz. If the capacitances in the parallel oscillator circuit 25 and the series oscillator circuit 28 are quadrupled by simultaneously switching-on the further capacitors 36 and 37, the lower one of the two operating frequencies is reduced to half its prior value, i.e. to 75 kHz, and the higher one of the two operating frequencies to half its prior value, i.e. to 300 kHz. The frequency ratio of the two operating frequencies of 1:4 remains unchanged.

In a particular embodiment of the oscillator circuit 23 of the receiver device 11 according to FIG. 5 for an apparatus 1 for detecting metal objects 2 with low operating frequencies, if only the capacitances of the partial capacitors 32 and the capacitor 24 are active, the lower one of the two operating frequencies is 75 kHz and the higher one of the two operating frequencies is 300 kHz. If the capacitances in the parallel oscillator circuit 25 and the series oscillator circuit 28 are quadrupled by parallelly switching on the further capacitors 36 and 37, the lower one of the two operating frequencies is reduced to half its prior value, i.e. to 37.5 kHz, and the higher one of the two operating frequencies to half its prior value, i.e. to 150 kHz. The frequency ratio of the two operating frequencies of, also here, 1:4 remains unchanged.

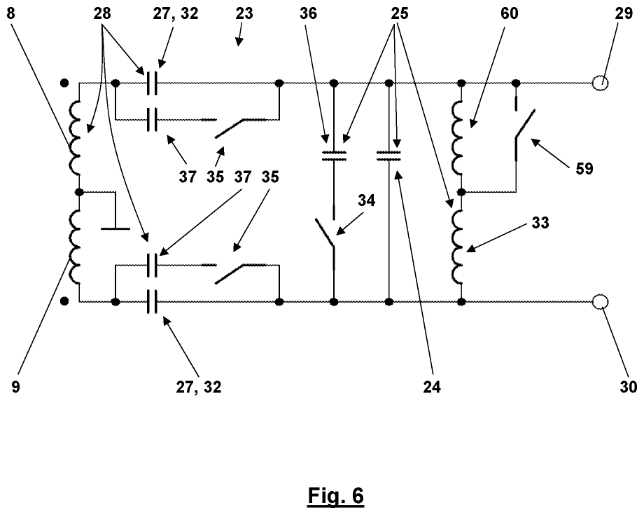

FIG. 6 shows how the frequency ratio of the resonance frequencies may be varied in that, here by opening a switch 59 and concomitantly connecting an, at first, shorted further coil 60 in series with the coil 33, the inductance of the parallel oscillator circuit 25 is increased.

As compared to the above indicated practical embodiment of the oscillator circuit 23 of the receiver device 11 according to FIG. 5 for an apparatus 1 with switched-on further capacitors 36 and 37 and the resulting operating frequencies of 75 kHz and 300 kHz, the increase of the inductance of the parallel oscillator circuit 25 by means of the further coil 60 with a simultaneous reduction of the capacitance of the parallel oscillator circuit 25 by means of opening the switch 34 results in a selective duplication of the higher one of the two operating frequencies to 600 kHz. Correspondingly, the frequency ratio of the two operating frequencies is doubled from 1:4 to 1:8.

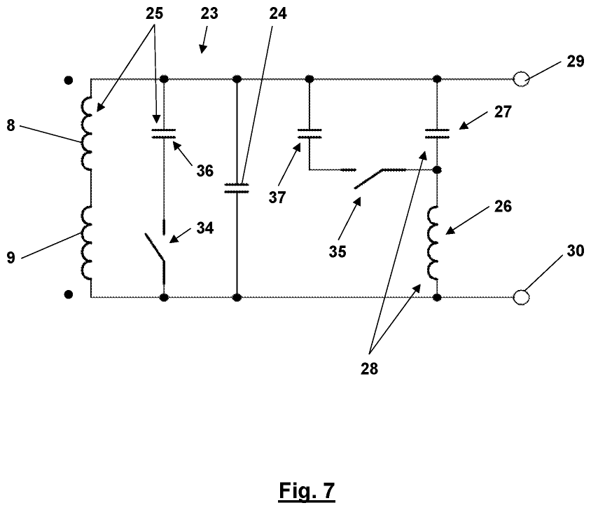

FIG. 7 shows how, in the multi-resonant oscillator circuit 23 in the general embodiment according to FIG. 3, in which the receiver coils 8 and 9 are part of the parallel oscillator circuit, the capacitances in all partial oscillator circuits may be increased by means of the capacitors 36 and 37 which may be switched-on with the switches 34 and 35. By means of switching-on the capacitors 36 and 37, all resonance frequencies of the oscillator circuit 23 are reduced, and by means of switching the capacitors 36 and 37 off, all resonance frequencies of the oscillator circuit 23 increased.

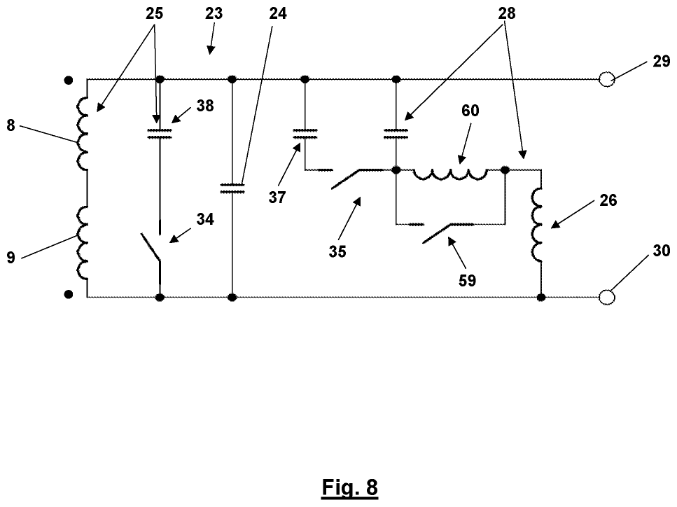

FIG. 8 shows how the frequency ratio of the resonance frequencies may additionally be varied in that, here by means of opening the switch 59 and concomitantly connecting the, at first, shortened further coil 60 in series with the coil 26, the inductance of the series resonator circuit 28 is increased.

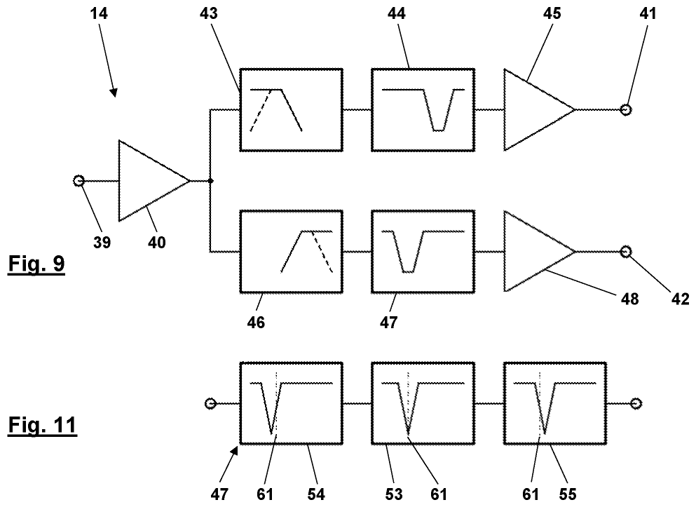

FIG. 9 illustrates an embodiment of the filter device 14 according to FIG. 1 for that case that the apparatus 1 is simultaneously operated at two operating frequencies. An input amplifier 40 is connected to a signal input 39. Two different signal processing paths follow towards two signal outputs 41 and 42. In one of the signal processing paths, a low pass filter 43 is connected in series with a band elimination filter 44 operating at the higher one of the two operating frequencies and an output amplifier 45 so that, at the output connector 41, a partial signal with the lower one of the two operating frequencies is present. In the other signal processing path, a high path filter 46 is connected in series with a band elimination filter 47 effective at the lower one of the two operating frequencies and an output amplifier 48 such that, at the output connector 42, a partial signal with the higher one of the two operating frequencies is present. The two output connectors 41 and 42 are connected to the analysis device 13 according to FIG. 1.

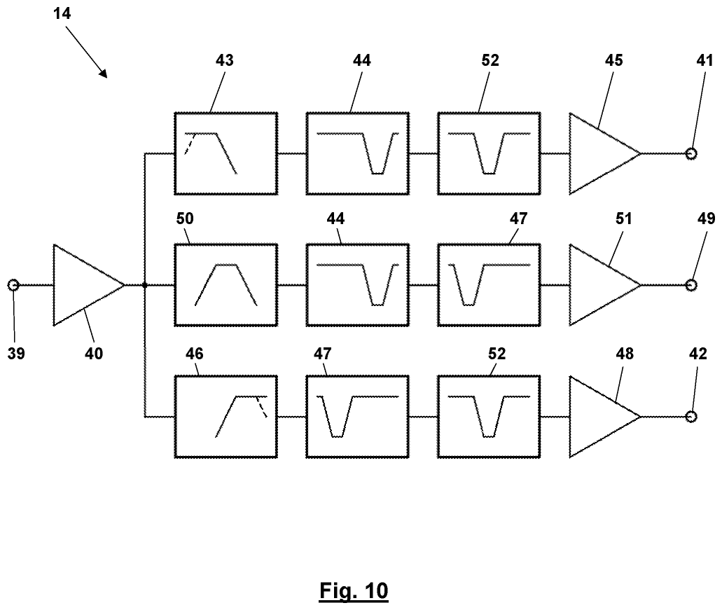

FIG. 10 shows an embodiment of the filter device 14 for three operating frequencies of the apparatus 1. Correspondingly, there is an additional signal output 49 for a third partial signal. In the signal path towards the additional signal output 49, a broad-band band path filter 50 with copies of the band elimination filter 44 for the highest of the three operating frequencies and the band elimination filter 47 for the lowest of the three operating frequencies and an output amplifier 51 are connected in series. Thus, at the additional signal output 49, the third partial signal with the middle one of the operating frequencies is output. In the signal path towards the signal outputs 41 and 42, additional band elimination filters 52 for the middle one of the three operating frequencies are arranged to also eliminate this one from the partial signals with the lowest and the highest of the two operating frequencies output at the output connectors 41 and 42, respectively.

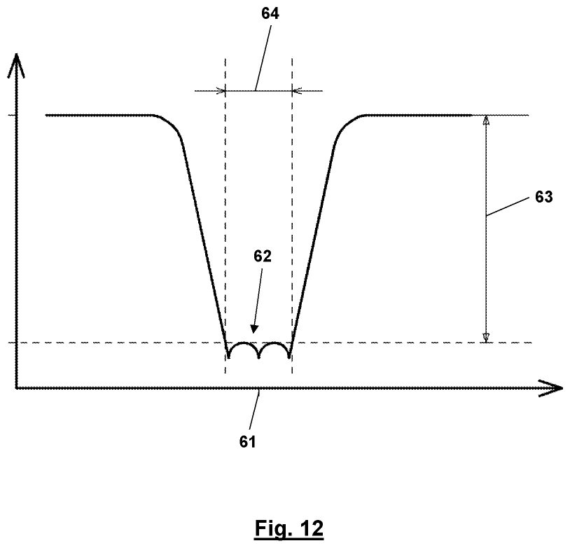

The band elimination filters 44, 47, 52 according to FIGS. 9 and 10 may be band elimination filters of larger width and, for this purpose, each consist of a group of three individual notch filters, like depicted in FIG. 11 for the band elimination filter 47. A notch filter 53 having a central filter frequency 61 is connected in series with a notch filter 54 having a slightly downwards shifted filter frequency and a notch filter 55 having a slightly upwards shifted filter frequency. In total, there is a transmission spectrum or filter function of the band elimination filter 47 as depicted in FIG. 12 having a blocking range 62 of high attenuation 63 and large width 64 around the central filter frequency 61, in which the band elimination filter 47 strongly suppresses the receiver signal. In practice, the attenuation 63 of the elimination range may be in a range from −70 dBc to −60 dBc and the width 64 may, at the same time, be 10% to 20% of the central filter frequency 61.

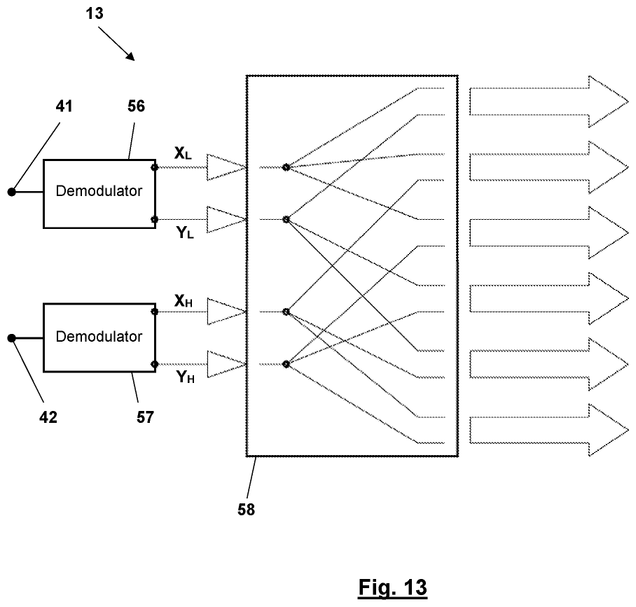

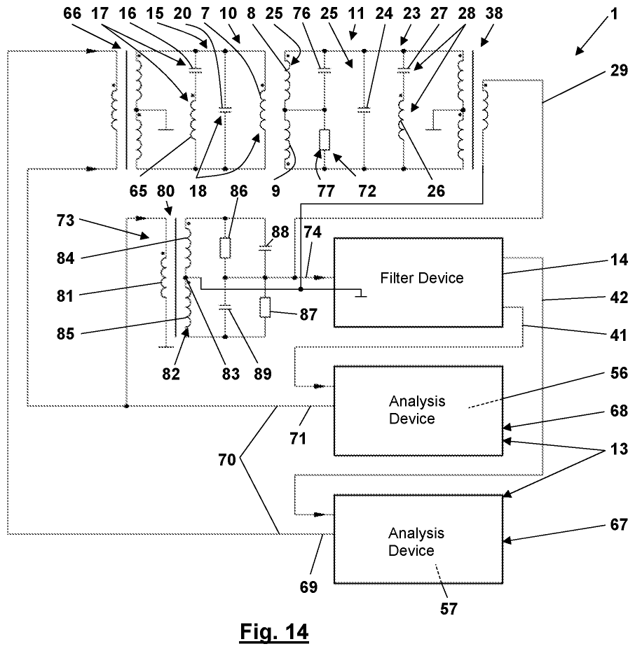

FIG. 13 illustrates a part of the analysis device 13 of the apparatus 1 so far as operating at two operating frequencies. The partial signals obtained from the signal outputs 41 and 42 according to FIG. 9 are demodulated by demodulators 56 and 57 using a reference signal of the respective operating frequency. The results are temporal courses of quadrature components having the values x_{L} and y_{L} at the lower operating frequency and x_{H} and y_{H} at the higher operating frequency, from which the phase and the amplitude of the respective partial signal may be reconstructed at certain points in time which correspond to the relative positions of the article 3 relative to the apparatus 1 according to FIG. 1. In a unit 58 of the analysis device 13, the individual values are temporarily and positionally interrelated. Thus, an enlarged database for the detection of metal objects in and on the articles 3 is present, which allows for detecting the metal object 2, even if the articles 3 are themselves electrically conductive or have other pronounced electric or dielectric properties and, thus, themselves strongly influence the alternating magnetic field generated using the transmitter coil 7. It is not indicated in FIG. 13 that—alternatively or additionally with respect to the values directly calculated from the partial signal—also values of difference signals between the partial signals as they are occurring with a particular article 3, and of partial signals as they are occurring with a reference article without metal object 2 may be analyzed.

The embodiment of apparatus 1 depicted in FIG. 14 comprises the receiver device 11 having the oscillator circuit 23 and the transformer 38 according to FIG. 3 and the transmitter device 10 in a corresponding design with arrangement of the transmitter coil 7 together with the capacitor 20 in the parallel oscillator circuit 18 and a further coil 65 together with the capacitor 16 in the series oscillator circuit 17. A transformer 66 serves for coupling-in an excitation signal 70. One part 69 of the excitation signal 70 comes from first electronics 67, and another part 71 comes from second electronics 68. The electronics 67 inter alia includes the demodulator 57, whereas the second electronics 68 includes the demodulator 56 according to FIG. 13. Thus, the electronics 67 and 68 form the analysis device 13. Additionally, they include alternating voltage sources for the part 69 of the excitation signal 70 for the transmitter device 10 having the higher one of the two operating frequencies, and for the part 71 of the excitation signal 70 having the lower one of the two operating frequencies. Further, FIG. 14 shows two balancer devices 72 and 73. The balancer devices 72 and 73 are part of the receiver device 11 and serve for balancing the receiver signal at a signal output 74 at both operating frequency towards zero, before the alternating field generated using the transmitter coil 7 is influenced by an article to be examined for a metal object. In the present embodiment, the balancer device 72 for the higher one of the two operating frequencies comprises at least one capacitor or one ohmic resistor which is connected in parallel to one of the two receiver coils 8 and 9, respectively. In FIG. 14, a capacitor 76 connected in parallel to the receiver coil 8 and an ohmic resistor 77 connected in parallel to the receiver coil 9 are depicted. The capacitor 76 and the ohmic resistor 77 need not to be present at the same time. The positions of the capacitor 76 and the ohmic resistor 77 may be interchanged, or both a capacitor and an ohmic resistor may be connected in parallel to at least one of the receiver coils 8 and 9. By means of the at least one of the capacitor and the ohmic resistor connected in parallel to the at least one of the receiver coils 8 and 9, the balancer circuit 72 compensates for differences between the two receiver coils 8 and 9 at the higher one of the two operating frequencies directly within the oscillator circuit 23 of the receiver device 11. The balancer device 73 for the lower one of the two operating frequencies comprises a transformer 80, wherein the part 71 of the excitation signal 70 for exciting the transmitter device 10 at the lower operating frequency is present at the primary winding 81 of the transformer 80. The secondary winding 82 of the transformer 80 comprises a center point 83 and two equal winding halves 84 and 85 on both sides of the center point 83. The center point 83 is connected to the reference ground of the signal output 74 for the receiver signal. At least one capacitor or one ohmic resistor is connected in parallel to one of the two winding halves 84 and 85 towards the signal output 74. In order to show all options, it is depicted in FIG. 14, that an ohmic resistor 86 and a capacitor 88 are connected in parallel to the winding half 84, and that an ohmic resistor 87 and a capacitor 89 are connected in parallel to the winding half 85 towards the signal output 74. So far as present, the ohmic resistors 86 and 87, respectively, and the capacitors 88 and 89, respectively, are dimensioned such that, with the balancer device 73, a balancer signal is added to the signal output 74, which is opposing the receiver signal at the lower one of the two operating frequencies such that it is balanced towards zero as long as no article to be examined has an influence on the alternating magnetic field of the transmitter coil 7. Both balancer devices 72 and 73 compensate for practical deficiencies of the measurement arrangement having the transmitter coil 7 and the receiver coils 8 and 9. In a measurement arrangement which is ideal in every aspect, the balancer devices 72 and 73 would not be necessary; in any real measurement arrangement they may be advantageous.

Many variations and modifications may be made to the preferred embodiments of the invention without departing substantially from the spirit and principles of the invention. All such modifications and variations are intended to be included herein within the scope of the present invention, as defined by the following claims.

I claim:

1. An apparatus for detecting metal objects in and on articles moving relative to the apparatus, the apparatus comprising
a transmitter device including a transmitter coil and configured for generating a magnetic alternating field at multiple operating frequencies using the transmitter coil,
a receiver device including at least one receiver coil and configured for detecting the magnetic alternating field influenced by the moving articles and for outputting a receiver signal as a function of the detected magnetic alternating field,
a filter device configured for filtering multiple partial signals out of the receiver signal, each of the partial signals being associated with one of the operating frequencies, and
an analysis device configured for analyzing the partial signals,
wherein the filter device is configured for band-elimination filtering each of the partial signals which is associated with one of the operating frequencies with regard to all others of the operating frequencies.

2. The apparatus of claim 1, wherein the filter device comprises a group of notch filters for each of the partial signals and for each of the others of the operating frequencies to be band-elimination filtered.

3. The apparatus of claim 2, wherein each group of the notch filters comprises
a first notch filter having a first central filter frequency, and
at least one of a second notch filter having a second central filter frequency which is lower than the first central filter frequency, and a third notch filter having a third central filter frequency which is higher than the first central filter frequency.

4. The apparatus of claim 3, wherein the second central filter frequency of the second notch filter is by 1% to 10% lower than the first central filter frequency of the first notch filter, and the third central filter frequency of the third notch filter is by 1% to 10% higher than the first central filter frequency of the first notch filter.

5. The apparatus of claim 3, wherein the first central filter frequency of the first notch filter is tuned to the respective operating frequency of the others of the operating frequencies to be band-elimination filtered.

6. The apparatus of claim 1, wherein the filter device comprises at least one of a band pass filters, a low pass filter and a high pass filter for each partial signal, wherein each edge of the respective filter keeps a distance of at least 10% of the operating frequency with which the respective partial signal is associated to the operating frequency with which the respective partial signal is associated.

7. The apparatus of claim 1, wherein at least one of the transmitter coil and the at least one receiver coil is part of a multi-resonant oscillator circuit which has a resonance frequency at each of the multiple operating frequencies.

8. The apparatus of claim 7, wherein each multi-resonant oscillator circuit comprises interconnected partial oscillator circuits.

9. The apparatus of claim 8, wherein the interconnected partial oscillator circuits include a series oscillator circuit and a parallel oscillator circuit.

10. The apparatus of claim 1, wherein the transmitter device is switchable between a plurality of predetermined sets of operating frequencies.

11. The apparatus of claim 7,
wherein the transmitter device is switchable between a plurality of predetermined sets of operating frequencies, and
wherein each multi-resonant oscillator circuit is switchable to adapt its resonance frequencies to the respective set of operating frequencies in that the capacitances in all of the partial oscillator circuits interconnected in the respective multi-resonant oscillator circuit are switchable between predetermined values.

12. The apparatus of claim 7, wherein each multi-resonant oscillator circuit, at each of the multiple operating frequencies, has a quality factor of at least 10.

13. The apparatus of claim 1, wherein the analysis device is configured for demodulating each of the partial signals with respect to contained phase information using a reference signal of that one of the multiple operating frequencies which is associated with the respective partial signal.

14. The apparatus of claim 1, wherein the receiver device has two equal receiver coils which are symmetrically arranged in planes which are parallel to the transmitter coil and which are connected in series in a quadrupole configuration in the receiver device.

15. The apparatus of claim 14, wherein the two equal receiver coils of the receiver device have a same geometry as the transmitter coil.

16. The apparatus of claim 14,
wherein the two equal receiver coils are parts of a resonant oscillator circuit of the receiver device, and
wherein the two equal receiver coils of the receiver device are connected in series in the oscillator circuit.

17. The apparatus of claim 14, wherein the receiver device, for each of the operating frequencies, comprises a separate balancer device which is configured for balancing the receiver signal at the respective operating frequency towards zero when the magnetic alternating field is not influenced by the moving articles.

18. The apparatus of claim 17, wherein
one of the balancer devices comprises at least one of a capacitor and an ohmic resistor which is connected in parallel to one of the two receiver coils, and
another one of the balancer devices comprises a transformer, a part of an excitation signal for exciting the transmitter device at the associated operating frequency being present at a primary winding of the transformer, and a secondary winding of the transformer having two winding halves and a center point between the two winding halves, wherein the center point is connected to a reference ground of a signal output of the receiver device for the receiver signal, and wherein at least one of a capacitor and an ohmic resistor is connected between one of the winding halves of the secondary winding and the signal output.

19. The apparatus of claim 1, wherein the analysis device is configured for interrelating the information obtained at the multiple operating frequencies in order to detect the metal object in the articles moving relative to the apparatus.

20. The apparatus of claim 19, wherein the analysis device is configured for interrelating the information obtained at the multiple operating frequencies depending on a position of the respective article with relative to the apparatus or depending on the point in time of the information.
